(19) United States
(12) Patent Application Publication
(10) Pub. No.: US 2008/0213498 A1
(43) Pub. Date: Sep. 4, 2008

(54) Reinforced composite with a tow of fibers and process for the preparation thereof

(75) Inventors: Lawrence T. Drzal, Okemos, MI (US); Hiroyuki Fukushima, Lansing, MI (US); Robert Jurek, Lebanon, OH (US); Michael Rich, Williamston, MI (US)

Correspondence Address: Ian C. McLeod;IAN C. McLEOD, P.C., 2190 Commons Parkway, Okemos, MI, 48864, US

(73) Assignee: Board of Trustees of Michigan State University, East Lansing, MI (US)

(21) Appl. No.: 12/072,460

(22) Filed: Feb. 26, 2008

Related U.S. Application Data
(63) Continuation-in-part of application No. 11/801,261, filed on May 9, 2007.
(60) Provisional application No. 60/800,604, filed on May 16, 2006.

(51) Int. Cl. B05D 1/04; B32B 9/00; C08K 3/04

(52) U.S. Cl. 427/475; 428/368; 427/372.2; 524/612; 524/424

(57) ABSTRACT

A graphite coated tow of fibers having exfoliated and pulverized graphite platelets coated on an outer surface of the fibers are provided. A process is provided for surface coating of the graphite platelets onto the fibers. The graphite coated tow of fibers are used to produce a reinforced composite material. Reinforced composite materials incorporating the graphite coated fibers can be electrostatically painted without using a conductive primer on a surface to be painted.

### CROSS-REFERENCE TO RELATED APPLICATIONS

This application is a continuation-in-part of U.S. patent application Ser. No. 11/801,261, filed May 9, 2007, which claims priority to U.S. Provisional Application No. 60/800,604 filed May 16, 2006, each of which are incorporated herein by reference in their entirety.

### STATEMENT REGARDING FEDERALLY SPONSORED RESEARCH OR DEVELOPMENT

Not applicable.

### STATEMENT REGARDING GOVERNMENT RIGHTS

Not Applicable.

### BACKGROUND OF THE INVENTION

(1) Field of the Invention

The present invention relates to fiber reinforcements derived from a tow of fibers which are coated with exfoliated graphite platelets and then are incorporated into the polymer matrix of composite materials. The resulting composites in particular are electrically conductive.

(2) Description of Related Art

Nanocomposites composed of polymer matrices with reinforcements of usually less than 100 nm in size, are being considered for applications such as interior and exterior accessories for automobiles, structural components for portable electronic devices, and films for food packaging (Giannelis, E. P., Appl. Organometallic Chem., Vol. 12, pp. 675 (1998); and Pinnavaia, T. J. et al., Polymer Clay Nanocomposites. John Wiley & Sons, Chichester, England (2000)). While most nanocomposite research has focused on exfoliated clay platelets, the same nanoreinforcement concept can be applied to another layered material, graphite, to produce nanoplatelets and nanocomposites (Pan, Y. X., et al., J. Polym. Sci., Part B: Polym. Phy., Vol. 38, pp. 1626 (2000); and Chen, G. H., et al., J. Appl. Polym. Sci. Vol. 82, pp. 2506 (2001)).

U.S. Patent Application No. 2004/0077771 to Wadahara et al. describes the use of a filler combination of carbon fiber and vapor grown carbon fiber or nanotube as a filler system primarily in thermoplastic resin systems. The patent application and references cited show the conductivity of the composites, is improved. But the resulting composites did not show significant improvement in mechanical properties.

Thorstenson et al., (J. Appl. Phys., 91, 9, 6034, 2002) and Kowbwl et al., ((Composites, Part A., 28A, 993, 1997) and others have reported that depositing nanomaterials, such as carbon nanotube and silicon nitride, on carbon fibers by chemical vapor deposition can improve adhesion to matrix such as epoxy and phenolic resin. But chemical vapor deposition is a complex, expensive process and the cost of the resulting nanomaterial-deposited fiber is very high.

Graphite is the stiffest material found in nature (Young's Modulus=1060 MPa), having a modulus several times that of clay, but also with excellent electrical and thermal conductivity. With the appropriate surface treatment, exfoliation and dispersion in a thermoset or thermoplastic polymer matrix results in a composite with excellent mechanical, electrical and thermal properties, opening up many new structural applications as well as non-structural ones where electromagnetic shielding and high thermal conductivity are requirements as well. Furthermore, the economics of producing nanographite platelets indicate a cost of $10 per pound or less could be attainable.

Graphite occurs in natural and synthetic form and is well described in the literature. Illustrative of this art is a monograph by Michel A. Boucher, Canadian Minerals Yearbook 24.1-24.9 (1994). A useful form of graphite is expanded graphite which has been known for years. The first patents related to this topic appeared as early as 1910 (U.S. Pat. Nos. 1,137,373 and 1,191,383). Since then, numerous patents related to the methods and resulting expanded graphites have been issued. For example, many patents have been issued related to the expansion process (U.S. Pat. Nos. 4,915,925 and 6,149,972), expanded graphite-polymer composites (U.S. Pat. Nos. 4,530,949, 4,704,231, 4,946,892, 5,582,781, 4,091,083 and 5,846,459), flexible graphite sheet and its fabrication process by compressing expanded graphite (U.S. Pat. Nos. 3,404,061, 4,244,934, 4,888,242, 4,961,988, 5,149,518, 5,294,300, 5,582,811, 5,981,072 and 6,143,218), and flexible graphite sheet for fuel cell elements (U.S. Pat. Nos. 5,885,728 and 6,060,189). Also there are patents relating to grinding/pulverization methods for expanded graphite to produce fine graphite flakes (U.S. Pat. Nos. 6,287,694, 5,330,680 and 5,186,919). All of these patents use a heat treatment, typically in the range of 600° C. to 1200° C., as the expansion method for graphite. The heating by direct application of heat generally requires a significant amount of energy, especially in the case of large-scale production. Radiofrequency (RF) or microwave expansion methods can heat more material in less time at lower cost. U.S. Pat. No. 6,306,264 to Kwon et al. discusses microwave as one of the expansion methods for SO₃ intercalated graphite.

U.S. Pat. Nos. 5,019,446 and 4,987,175 describe graphite flake reinforced polymer composites and the fabrication method. These patents did not specify the methods to produce thin, small graphite flakes. The thickness (less than 100 nm) and aspect ratio (more than 100) of the graphite reinforcement was described.

U.S. Pat. Nos. 4,777,336 to Asmussen et al., 5,008,506 to Asmussen, 5,770,143 to Hawley et al., and 5,884,217 to Hawley et al. describe various microwave or radiofrequency wave systems for heating a material. These applications and patents are hereby incorporated herein by reference in their entirety.

### SUMMARY OF THE INVENTION

The present invention provides a tow of graphite and polymer coated fibers comprising fibers having an outer surface; and exfoliated and pulverized graphite platelets coated on the outer surface of the fibers with a binding agent which is a polymer derived from a thermoset or thermoplastic polymer to provide the graphite and polymer coated fiber. In further embodiments, the tow of fibers are selected from the group consisting of carbon fibers, glass fibers, ceramic fibers, and polymeric fibers. In still further embodiments, the weight fraction of platelets on the outer surface of the fiber is from about 0.1 to about 5 weight percent of the coated fiber and the platelets have a particle size between about 100 nanometers and 15 microns. In further still embodiments, the tow of fibers are polymer fibers.

The present invention further provides a reinforced composite material which comprises a polymeric matrix; and coated fibers comprising fibers having an outer surface; and exfoliated and pulverized graphite platelets coated on the outer surface of the fibers with a binding agent which is a polymer coating derived from a thermoset or thermoplastic polymer to provide the graphite and polymer coated fiber, wherein optionally the coated fibers can be cut into smaller units. In further embodiments, the tow of fibers are carbon fibers. In still further embodiments, the weight fraction of exfoliated graphite platelets on the outer surface of the carbon fiber is from about 0.1 to about 5 weight percent of the coated fibers and the platelets have a particle size between about 100 nanometers and 15 microns. In further still embodiments, the tow of fibers are polymer fibers. In still further embodiments, the polymeric matrix comprises a thermoset or thermoplastic polymer.

The present invention still further provides a continuous process for the production of a tow of graphite and thermoset polymer coated fibers comprising the steps of providing a tow of fibers from a continuous source of uncoated fibers; providing a graphite solution comprising exfoliated and pulverized graphite particles and a binder polymer in a solvent; continuously coating the tow of fibers with the graphite solution; fixing the polymer on the fibers at elevated temperatures to provide the thermoset polymer and graphite coated fibers; and continuously collecting the cured thermoset polymer graphite coated fibers. In further embodiments, the graphite solution is between about 0.1 and 5 weight percent of the exfoliated and pulverized graphite in the solution and the platelets have a particle size between about 100 nanometers and 15 microns.

The present invention still further provides a method of electrostatic painting of a reinforced composite material without using a conductive primer comprising the steps of providing a reinforced composite material which comprises a polymeric matrix; and coated fibers comprising fibers having an outer surface; and exfoliated and pulverized graphite platelets coated on the outer surface of the fibers with a binding agent which is a polymer coating derived from a thermoset or thermoplastic polymer to provide the graphite and polymer coated fiber, wherein optionally the coated fibers can be cut into smaller units; electrically grounding the reinforced composite material; providing charged droplets comprising a resin and a pigment; spraying the charged droplets onto the electrically grounded reinforced composite material so as to coat the material; and curing the droplets on the reinforced composite material in a curing oven, so as to electrostatically paint the reinforced composite material with the powder. In further embodiments, the weight fraction of platelets on the outer surface of the carbon fiber is from about 0.1 to about 5 weight percent of the coated fiber and the platelets have a particle size between about 100 nanometers and 15 microns. In still further embodiments, the fibers are carbon fibers, glass fibers, ceramic fibers, or polymeric reinforcing fibers.

The present invention still further provides a method for producing a composite composition comprising a tow of fibers in a thermoset or thermoplastic polymer matrix, which comprises providing a tow of graphite and polymer coated fibers comprising fibers having an outer surface; and exfoliated and pulverized graphite platelets coated on the outer surface of the fibers with a binding agent which is a thermoset polymer to provide the graphite and polymer coated fiber; and combining the coated fibers or chopped fibers therefrom with the polymer matrix to produce the composite composition. In further embodiments, the polymer matrix is an epoxy. In still further embodiments, the tow of fibers are unsized carbon fibers. In still further embodiments, the weight fraction of platelets on the outer surface of the carbon fiber is from about 0.1 to about 5 weight percent of the coated fiber and the platelets have a particle size between about 100 nanometers and 15 microns. In further still embodiments, the matrix polymer is derived from a bisphenyl epoxy polymer precursor and a heat activated aromatic amine hardener. In still further embodiments, the hardener is ethyltoluene amine.

The present invention still further provides a composite composition comprising the tow of graphite and polymer coated fibers; and a polymer matrix. In further embodiments, the tow of fibers are unsized carbon fibers. In further still embodiments, the tow of fibers are polymer fibers. In still further embodiments, the polymer matrix is a thermoset polymer matrix. In further still embodiments, the polymer matrix is a thermoplastic polymer matrix. In still further embodiments, a hardener for an epoxy resin polymer matrix is ethyltoluene amine.

### BRIEF DESCRIPTION OF THE DRAWINGS

FIG. 1 is a schematic drawing of an apparatus 10 for the coating of a tow of fibers 11.

FIGS. 2A and 2B are SEM photographs of uncoated and coated fibers, respectively. FIG. 2A are nanoparticle coated fibers, (FIG. 2B).

FIGS. 3A to 3E show the strength properties of the coated fibers versus the coated fibers in an epoxy matrix.

FIGS. 4A, 4C and 4E, show the fibers and composites without the graphite platelets. FIGS. 4B, 4D and 4F, show the fibers with graphite platelets coated on them. FIG. 4A is a perspective drawing of fiber with control coating (only epoxy coating); FIG. 4B is a perspective drawing showing fiber with graphite coating (graphite+epoxy coating); FIG. 4C is a perspective drawing showing a prepreg based on fibers with control coating (only epoxy coating); FIG. 4D is a perspective drawing showing a prepreg based on fibers with graphite coating (graphite+epoxy coating); FIG. 4E is a perspective drawing showing a laid-up composite made of prepreg based on fibers with control coating (only epoxy coating); and FIG. 4F is a perspective drawing showing a laid-up composite made of prepreg based on fibers with graphite coating (graphite+epoxy coating).

### DESCRIPTION OF THE PREFERRED EMBODIMENTS

All patents, patent applications, government publications, government regulations, and literature references cited in this specification are hereby incorporated herein by reference in their entirety. In case of conflict, the present description, including definitions, will control.

As used herein the term “electrically insulating fiber” refers to any fiber with a surface electronic resistance of 10⁹ ohms/square or higher. Some examples include glass fibers or polymer fibers. The term “fiber” refers to any fiber. The term “tow of fibers” refers to two or more continuous strands of fibers which are coated. Typically, the tow has between about 1000 and 12,000 fibers as a bundle of fibers.

As used herein the term “low resistivity” refers to a high resistivity fiber coated with exfoliated and pulverized graphite platelets that has a lower surface resistivity than the resistivity of an untreated (raw) fiber.

As used herein the term “reinforced composite material” refers to a composite material having added reinforcements. The composite material can comprise any thermoset or thermoplastic polymeric matrix known in the art. The term “SMC” refers to sheet molding compound, a glass fiber reinforced polymeric material formed by compression molding.

The primary objective of the following Examples is to provide a hybrid (matrix, macrofiber, nanoparticle) composite with mechanical properties significantly improved over the macrofiber composite alone, by combining the graphite platelets, in a uniquely advantageous way so as to improve the overall composite properties. The continuous fiber is coated by the platelets so that the platelets cover at least 10% of the surface of the fiber and preferably more than 100%. The coating of the fiber can be achieved by using sizing/coating equipment and methods. The coating solution consists of the platelets, a sizing formulation selected for compatibility with the composite matrix and solvent. Resin, surfactant, polyelectrolyte, an emulsifying agent, or a combination of these can be formulated into a film former solution into which is added the nanoparticles. The composition of the coating solution and coating conditions are adjusted so that the reinforcing fiber can be completely and uniformly coated. The coated carbon fiber tow can be used in any composite fabrication processes such as prepregging operations, lay-up, spray up, pultrusion, and filament winding. Also the coated fiber can be chopped into short fibers and used in various composites including injection molding, extrusion, transfer molding, SMC (sheet molding compound), and like methods. As a result of this coating containing the nanographite platelet particles, the mechanical properties of the fabricated composite material are improved, including for example, the longitudinal flexural strength and modulus, the transverse flexural strength and modulus and the short beam shear strength. This composition and process can be applied to any continuous reinforcing fibers such as carbon, graphite, ceramic, glass, metal or polymeric fibers. The graphite platelets improve the electrical, thermal conductivity and barrier properties of the compounds as well as the mechanical properties.

High performance composites based in unidirectional or woven fibers, such as carbon fiber, glass fiber, and aramid fiber, have very high strength and modulus to weight ratio. But these materials often show low ductility and low toughness, especially in the interlaminar shear and transverse properties. Since internal damage is often very difficult to detect, it is important to improve these properties to subdue crack initiation. While incorporating an elastomer phase into matrix is a useful method to improve toughness of short fiber/particle based composites, it is usually not as effective for continuous fiber based composites.

The present method produces composites with improved mechanical properties. A coating is applied either in-line when the fiber is surface treated and sized or in a post-manufacturing operation prior to composite formation resulting in no loss in manufacturability and little additional cost. Any market that utilizes structural composite materials (e.g. aerospace, transportation, infrastructure, housing, and the like.) can improve the performance of composite materials made with this material and this process.

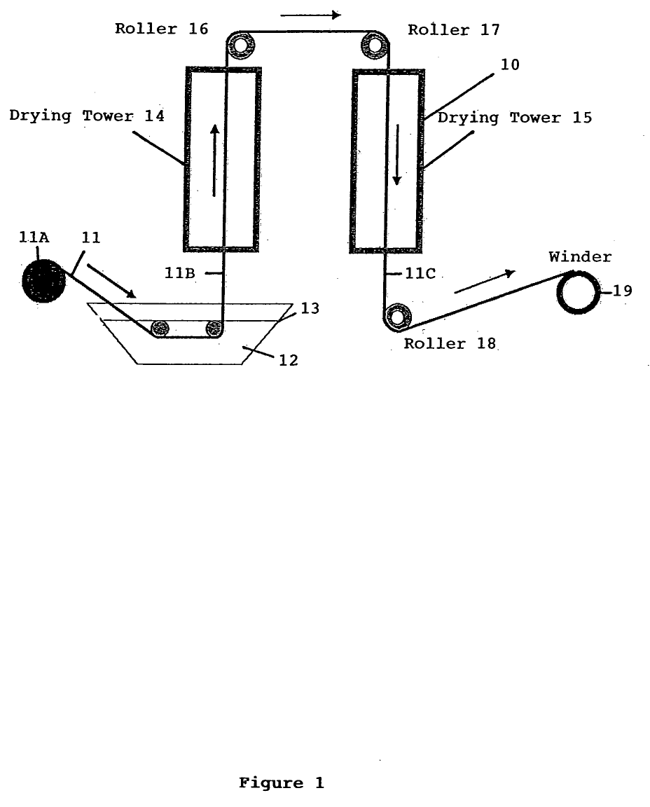

Graphite platelets are dispersed in a coating solution and used as a coating on continuous fiber samples, such as carbon fiber, glass fiber, or aramid fiber. Graphite platelets can be made by exfoliating acid intercalated graphite, pulverizing the exfoliated graphite, and milling the exfoliated graphite, as described in Published application Ser. No. 10/659,577, filed Sep. 10, 2003, assigned to a common assignee, which is incorporated by reference in its entirety herein. Specifically, the graphite and a small amount of emulsion agent are dispersed in 2-propanol (isopropanol) solvent to make a coating solution. The amount of graphite and epoxy must be adjusted so that the coating solution can be applied in a continuous manner resulting in a uniform coating on individual reinforcing fibers. The graphite platelet coating is applied to a continuous carbon fiber sample by using coating/sizing equipment, as shown in FIG. 1. The solvent is preferably dried right after the coating is applied. The coated fibers can be used in prepreg for lay-up, spray up, pultrusion, and filament winding. Also the coated fiber can be chopped into short fibers and used in various composites including injection molding, extrusion, transfer molding, SMC (sheet molding compound), etc. All of these composites can be made without significant changes to the conventional processing equipment.

Since individual molecular layers of graphite are held together with weak Van der Waals forces that are capable of being intercalated with organic or inorganic molecules. The intercalated molecules can be used for separation of the graphite layers to form expanded graphite. An expanded graphite is one that has been heated to separate individual platelets of graphite. An exfoliated graphite is a form of expanded graphite where the individual platelets are separated by heating with or without an agent such as a polymer or polymer component. The graphite expands to form very large platelets having large diameters and very thin thicknesses. The expanded graphite usually does not have any significant order as evidenced by a lack of x-ray diffraction patterns. The exfoliated graphite is pulverized to form the graphite platelets. As used herein the abbreviation “xGnP” refers to exfoliated nanographite platelets without an intercalating agent. Exfoliated nanographite platelets (xGnP) are exfoliated and pulverized graphite to a particle size between about 100 nanometers (0.1 micron) and 15 microns.

Expanded graphite platelets have interbasal plane surfaces with reactive sites on the edges of the platelets. Different chemical groups can be added to the edges. The application of an electric field can also be used to orient the expanded graphite platelets in a preferred direction creating materials which are electrically or thermally conductive in one direction. Submicron conductive paths can thus be created to act as nanosized wires.

The use of microwave (MW) energy or radiofrequency (RF) induction heating provides a fast and economical method to produce expanded graphite platelets. The microwave or radiofrequency methods are especially useful in large-scale production and are very cost-effective. The combination of radiofrequency or microwave expansion and appropriate grinding technique, such as planetary ball milling (and vibratory ball milling), produces nanoplatelet graphite flakes with a high aspect ratio efficiently. Microwave or radiofrequency expansion and pulverization of the crystalline graphite to produce suitable graphite flakes enables control of the size distribution of graphite flakes more efficiently. By incorporating an appropriate surface treatment, the process offers an economical method to produce a surface treated expanded graphite.

Chemically intercalated graphite flakes are expanded by application of the radiofrequency or microwave energy. The expansion occurs rapidly. Heating for three to five minutes removes the expanding chemical. The graphite absorbs the radiofrequency or microwave energy very quickly without being limited by convection and conduction heat transfer mechanisms. The intercalant heats up past the boiling point and causes the graphite to expand to many times its original volume. The process can be performed continuously by using a commercially available induction or microwave system with conveyors. Although a commercial microwave oven operating at 2.45 GHz was used for the following experiments, radio frequency (induction heating) or microwave frequency energy across a wide range can be used for this purpose.

In some embodiments, the intercalated graphite flakes are expanded by application of microwave energy at 2.45 GHz. Exfoliated and pulverized graphite and methods of producing the exfoliated and pulverized graphite are described in U.S. Patent Application Publication No. 2004/0127621 to Drzal et al. (copending U.S. patent application Ser. No. 10/659,577), filed Sep. 10, 2003, hereby incorporated herein by reference in its entirety. This microwave expansion process can be done continuously by using a commercially available microwave system with conveyors or the other devices as described in Drzal et al., U.S. patent application Ser. No. 11/435,350, filed May 16, 2006, assigned to a common assignee, hereby incorporated herein by reference in its entirety.

The graphite platelets can be dispersed in either organic or water based systems. In experiments conducted with both thermoset and thermoplastic polymers, exfoliated graphite nanoplatelets (xGnP) have been successfully dispersed and their mechanical, electrical, barrier and thermal properties have been measured. It was found that as little as about three (3) volume percent of the xGnP reduced the alternating current (AC) impedance by a factor of 10⁹ to 10¹⁰, a level sufficient to not only provide electrostatic charge dissipation, but also to decrease the electrical resistance to the point where the polymer composite has sufficient conductivity to undergo electrostatic painting and to function for electromagnetic interference (EMI) shielding.

The composite material can be applied to thermoset polymer systems, such as epoxy, polyurethane, polyurea, polysiloxane and alkyds, where polymer curing involves coupling or crosslinking reactions. The composite material can be applied as well to thermoplastic polymers for instance polyamides, proteins, polyesters, polyethers, polyurethanes, polysiloxanes, phenol-formaldehydes, urea-formaldehydes, melamine-formaldehydes, celluloses, polysulfides, polyacetals, polyethylene oxides, polycaprolactams, polycaprolactons, polylactides, polyimides, and polyolefins (vinyl-containing thermoplastics). Specifically included are polypropylene, nylon and polycarbonate. The polymer can be for instance an epoxy resin. The epoxy resin cures when heated. The epoxy composite material preferably contain less than about 8% by weight of the expanded graphite platelets. Thermoplastic polymers are widely used in many industries.

Epoxy matrix composites have been successfully fabricated using exfoliated graphite nanoplatelets (xGnP) of various diameters and at various concentrations up to three volume percent (3 vol %) as described in U.S. Patent Application Publication No. 2004/0127621 to Drzal et al. (copending U.S. patent application Ser. No. 10/659,577), filed Sep. 10, 2003. A flexural modulus of approximately 3.9 GPa could be attained with the xGnP which was significantly greater than composites reinforced with carbon fibers (CF), vapor grown carbon fibers (vgCF) and particulate carbon black (CB) at the same concentrations. The surface chemistry of the xGnP is important also. The flexural modulus of the acrylonitrile grafted surface has superior properties to the other surface treatments of xGnP.

The thermal and electrical properties of composites made from these reinforcements also showed significant differences based on the reinforcements size concentrations and morphology. Thermal conductivity measurements show that large exfoliated nanographite platelets can attain higher thermal conductivities than fibrous reinforcements or carbon black at the same concentration. Furthermore, there is a corresponding reduction in the coefficient of thermal expansion. Recent results at higher concentrations have reduced the coefficient of thermal expansion (CTE) to approximately forty μm/m/° C.

The percolation threshold of xGnP in epoxy composite is almost the same as CB and VGCF, and it was around 2 vol %. That of CF was around 10 vol %. The small concentration necessary for percolation is significant. This value is well beyond what is required for electrostatic spraying and into the regime where these materials would show electromagnetic interference (EMI) and radiofrequency (RF) shielding properties. Exfoliated graphite nanoplatelets can be produced as large, thin sheets. They can be produced inexpensively, suspended in water or organic solvent, deposited onto surfaces, dispersed in thermoset or thermoplastic polymers, and used to increase electrical conductivity. The ability to produce an electrically conductive SMC provides significant advantages for the automobile industry. The use of a conductive primer could be eliminated and electrostatic painting could be accomplished directly on the SMC part. Also, an SMC with EM shielding could be produced. Each of these contribute to the increased economic and performance attractiveness of SMC.

Since material electrical conductivity is largely dominated by surface conduction mechanisms, the ability to deposit xGnP on glass fibers in nanolayers thicknesses creates a unique opportunity to increase the conductivity of glass fibers without a significant increase in cost, change in composition, or change in processing. The xGnP can be dispersed in the sizing/finishing solution and applied to the glass fibers emerging from the production die in a manner similar to current sizing/finishing application procedures with little if any modification to the process.

Electrostatic painting can be accomplished on a reinforced composite material without using a conductive primer. An electrically conductive reinforced composite material of the present invention comprises a polymeric matrix and low resistivity graphite coated fibers mixed in the polymeric matrix. Each of the low resistivity coated fibers have exfoliated and pulverized graphite platelets on the outer surface of the fiber. The reinforced composite material has sufficient conductivity to undergo electrostatic painting and to provide EMI and RF shielding. To perform electrostatic painting the reinforced composite material is electrically grounded. A charged powder with a resin and a pigment is sprayed onto the electrically grounded reinforced composite material so as to coat the material. Next, the powder on the reinforced composite material is cured in a curing oven. Electrostatic painting apparatuses and methods are described in U.S. Pat. No. 4,660,771 to Chabert et al, U.S. Pat. No. 6,455,110 to Fortuyn et al., U.S. Pat. No. 6,659,367 to Ballu, and U.S. Pat. No. 6,776,362 to Kawamoto et al., each of which is hereby incorporated herein by reference in its entirety.

### EXAMPLE 1

Epoxy prepregs were made using a 12,000 filament tow to unsized carbon fibers which was coated with a sizing made of nanographite platelets. The prepregs contained about 1 vol percent of graphite platelets located on and around the surface of the fiber in the sizing layer. Unidirectional composites were fabricated via lamina layup and compression molding. The flexural strength in both parallel and transverse direction was improved more than 20% with addition of only about 1 vol percent of graphite. The experimental data is set forth herein.

Coating Solution Content.

Experimental Data

(1) Material
Continuous Fiber: Carbon Fiber Hexcel AS4 (No Sizing)
Graphite Platelets Thickness=10 nm, Diameter=1 um, 1 micron)
Emulsion Agent: Epoxy Resin EPN 862
Solvent: 2-propanol
Epoxy Matrix: Epon 862+EPICURE w (ethyltoluene amine;)

(2) Graphite Coating on Carbon Fiber
Coating Solution Content

TABLE 1

| | EPON 862 | Graphite | 2-propanol |
|---|---|---|---|
| Control Coating | 0.5 wt % | 0 wt % | 99.5 wt % |
| Graphite Coating | 0.5 wt % | 1 wt % | 98.5 wt % |

Coating on Carbon Fiber
Coating on Carbon Fiber

TABLE 2

| | Wt % Coating |
|---|---|
| Control Coating (no graphite) | 0.32 wt % |
| Graphite Coating | 3.04 wt % |

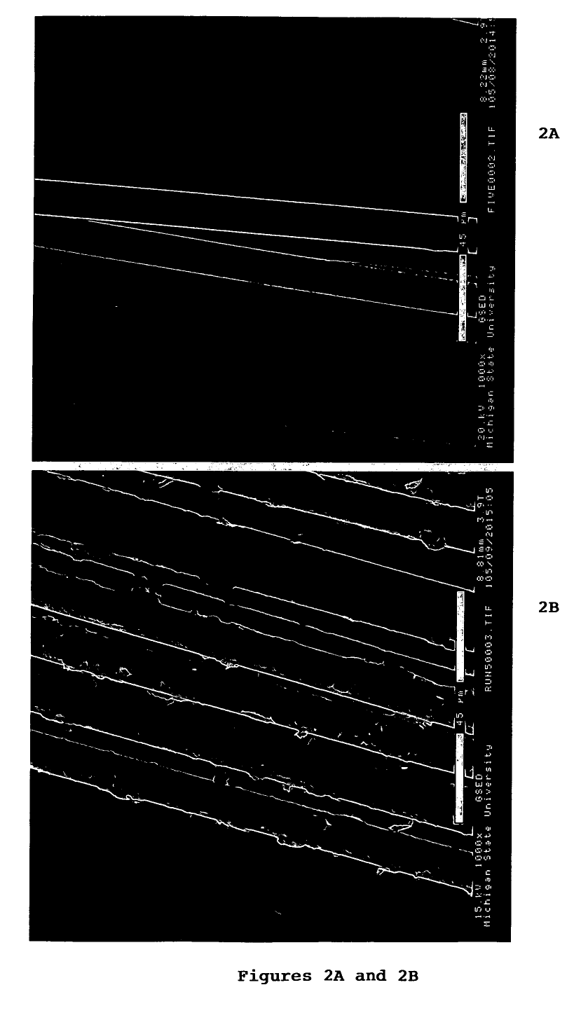

FIG. 1 shows system 10 for coating a tow of fibers 11 dispersed from a roll 11A with a coating solution 12 in a container 13. The coated fiber 11B is directed into heating towers 14 and 15 over rollers 16, 17 and 18. The dried coated fiber 11C is directed to a winder 19. FIG. 2A shows the uncoated tow of fibers 11 and FIG. 2B shows the coated tow of fibers 11C.

### EXAMPLE 2

Composite Fabrication
Prepreg samples were made from the coated fibers by using conventional prepregging equipment. The matrix used for the prepreg was epoxy. The prepreg samples were cut into 2″×6″ sheets and laid-up by hand with the coated tows of fibers in the center of the sheets. Each lay-up sample was cured at high temperature under pressure to eliminate voids.
Composite Sample

TABLE 3

| | Carbon | | Coating | |
|---|---|---|---|---|
| | Fiber | Epoxy Matrix | Graphite | Epoxy |
| Control | 64.50 vol % | 35.20 vol % | 0.00 vol % | 0.30 vol % |
| Coating | | | | |
| Graphite | 67.11 vol % | 30.57 vol % | 1.26 vol % | 1.06 vol % |
| Coating | | | | |

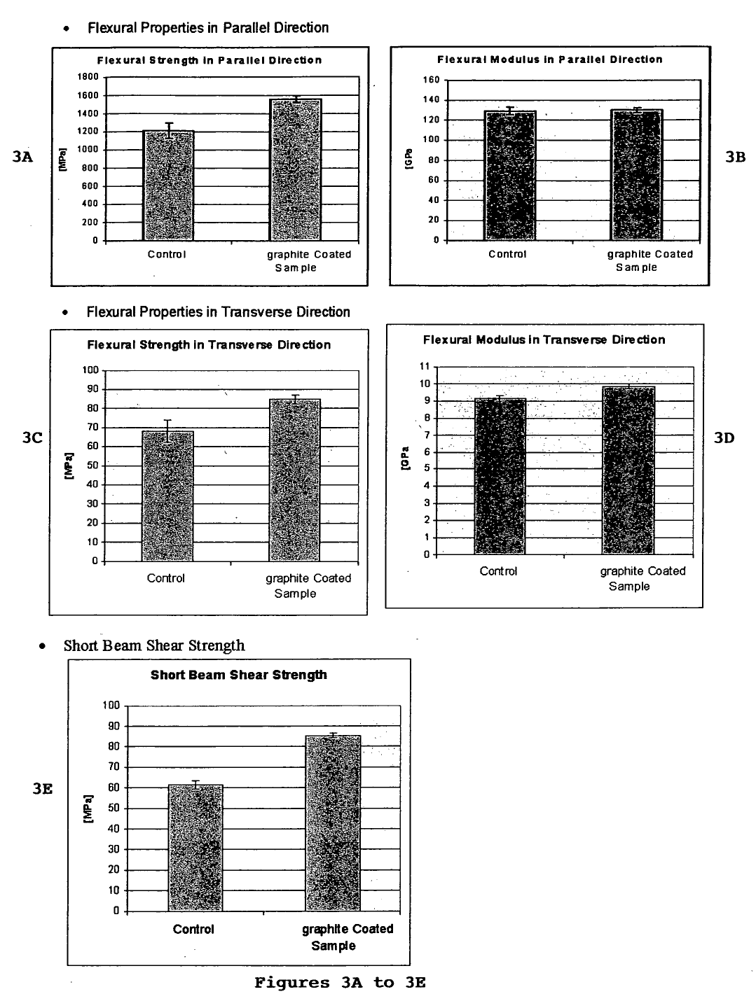

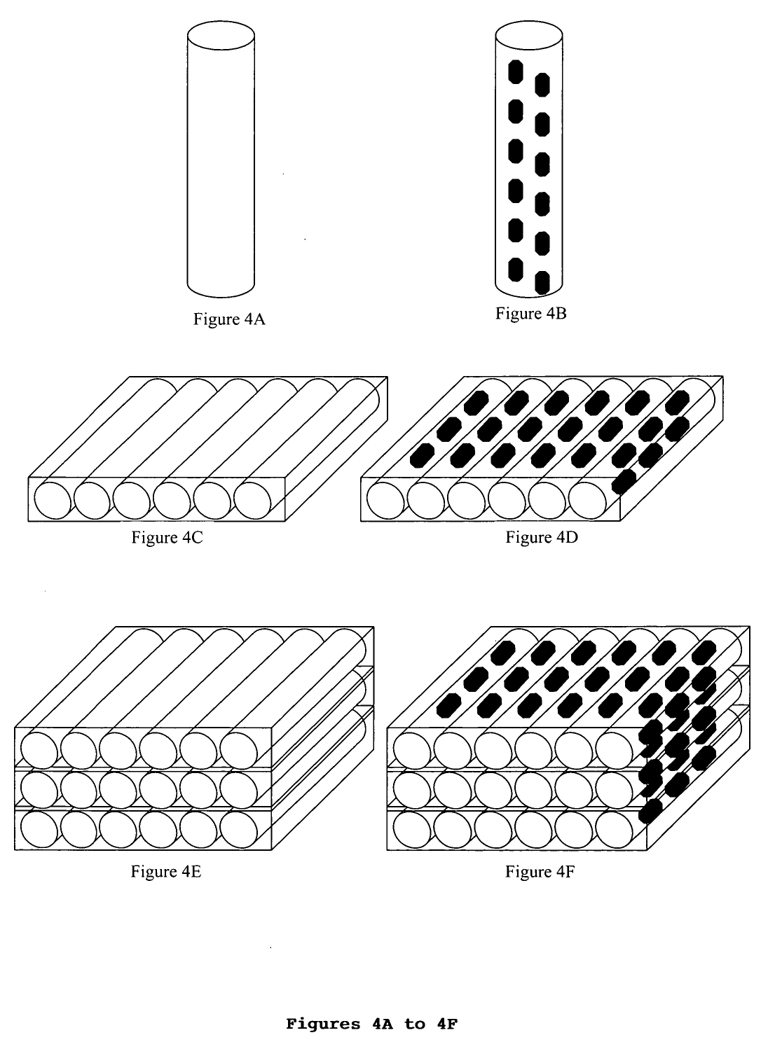

FIGS. 3A to 3E show the physical properties of epoxy composites prepared from the coated tow of fibers 11C. FIGS. 4A, 4C and 4E show the uncoated fibers. FIGS. 4B, 4D and 4F show the graphite platelet coated fibers.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the Claims attached herein.

We claim:

1. A tow of graphite and polymer coated fibers comprising:
(a) fibers having an outer surface; and
(b) exfoliated and pulverized graphite platelets coated on the outer surface of the fibers with a binding agent which is a polymer derived from a thermoset or thermoplastic polymer to provide the graphite and polymer coated fiber.

2. The tow of claim 1 wherein the tow fibers are selected from the group consisting of carbon fibers, glass fibers, ceramic fibers, and polymeric fibers.

3. The tow of claim 2 wherein the weight fraction of platelets on the outer surface of the fiber is from about 0.1 to about 5 weight percent of the coated fiber and the platelets have a particle size between about 100 nanometers and 15 microns.

4. The tow of claim 1 wherein the tow of fibers are polymer fibers.

5. A reinforced composite material which comprises:
(a) a polymeric matrix; and
(b) coated fibers comprising fibers having an outer surface; and exfoliated and pulverized graphite platelets coated on the outer surface of the fibers with a binding agent which is a polymer coating derived from a thermoset or thermoplastic polymer to provide the graphite and polymer coated fiber, wherein optionally the coated fibers can be cut into smaller units.

6. The reinforced composite material of claim 5 wherein the tow of fibers are carbon fibers.

7. The reinforced composite material of claim 6 wherein the weight fraction of exfoliated graphite platelets on the outer surface of the carbon fiber is from about 0.1 to about 5 weight percent of the coated fibers and the platelets have a particle size between about 100 nanometers and 15 microns.

8. The reinforced composite material of claim 5 wherein the tow of fibers are polymer fibers.

9. The reinforced composite material of claim 5 wherein the polymeric matrix comprises a thermoset or thermoplastic polymer.

10. A continuous process for the production of a tow of graphite and thermoset polymer coated fibers comprising the steps of:
(a) providing a tow of fibers from a continuous source of uncoated fibers;
(b) providing a graphite solution comprising exfoliated and pulverized graphite particles and a binder polymer in a solvent;
(c) continuously coating the tow of fibers with the graphite solution;
(d) fixing the polymer on the fibers at elevated temperatures to provide the thermoset polymer and graphite coated fibers; and
(e) continuously collecting the cured thermoset polymer graphite coated fibers.

11. The process of claim 10 wherein the graphite solution is between about 0.1 and 5 weight percent of the exfoliated and pulverized graphite in the solution and the platelets have a particle size between about 100 nanometers and 15 microns.

12. A method of electrostatic painting of a reinforced composite material without using a conductive primer comprising the steps of:
(a) providing a reinforced composite material which comprises a polymeric matrix; and coated fibers comprising fibers having an outer surface; and exfoliated and pulverized graphite platelets coated on the outer surface of the fibers with a binding agent which is a polymer coating derived from a thermoset or thermoplastic polymer to provide the graphite and polymer coated fiber, wherein optionally the coated fibers can be cut into smaller units;
(b) electrically grounding the reinforced composite material;
(c) providing charged droplets comprising a resin and a pigment;
(d) spraying the charged droplets onto the electrically grounded reinforced composite material so as to coat the material; and
(e) curing the droplets on the reinforced composite material in a curing oven, so as to electrostatically paint the reinforced composite material with the powder.

13. The method of claim 12 wherein the weight fraction of platelets on the outer surface of the carbon fiber is from about 0.1 to about 5 weight percent of the coated fiber and the platelets have a particle size between about 100 nanometers and 15 microns.

14. The method of claims 12 or 13 wherein the fibers are carbon fibers, glass fibers, ceramic fibers, or polymeric reinforcing fibers.

15. A method for producing a composite composition comprising a tow of fibers in a thermoset or thermoplastic polymer matrix, which comprises:
(a) providing a tow of graphite and polymer coated fibers comprising fibers having an outer surface; and exfoliated and pulverized graphite platelets coated on the outer surface of the fibers with a binding agent which is a thermoset polymer to provide the graphite and polymer coated fiber; and
(b) combining the coated fibers of (a) or chopped fibers therefrom with the polymer matrix to produce the composite composition.

16. The method of claim 15 wherein the polymer matrix is an epoxy.

17. The method of claims 15 or 16 wherein the tow of fibers are unsized carbon fibers.

18. The method of claims 15 or 16 wherein the weight fraction of platelets on the outer surface of the carbon fiber is from about 0.1 to about 5 weight percent of the coated fiber and the platelets have a particle size between about 100 nanometers and 15 microns.

19. The method of claim 15 wherein the matrix polymer is derived from a bisphenyl epoxy polymer precursor and a heat activated aromatic amine hardener.

20. The method of claim 19 wherein the hardener is ethyltoluene amine.

21. A composite composition comprising:
a) the tow of graphite and polymer coated fibers of claim 1; and
b) a polymer matrix.

22. The composite composition of claim 21 wherein the tow of fibers are unsized carbon fibers.

23. The composite composition of claim 22 wherein the tow of fibers are polymer fibers.

24. The composite composition of claim 22 wherein the polymer matrix is a thermoset polymer matrix.

25. The composite composition of claim 22 wherein the polymer matrix is a thermoplastic polymer matrix.

26. The composite composition of claim 25 wherein a hardener for an epoxy resin polymer matrix is ethyltoluene amine.
